(19) United States
(12) Patent Application Publication
(10) Pub. No.: US 2017/0068397 A1
(43) Pub. Date: Mar. 9, 2017

(54) Browsing Multiple Images Using Perspective Distortion and Scrolling

(71) Applicant: YAHOO! INC., Sunnyvale, CA (US)

(72) Inventors: Austin W. Shoemaker, San Francisco, CA (US); Josh Schwarzapel, Palo Alto, CA (US); Soujanya Bhumkar, Palo Alto, CA (US)

(21) Appl. No.: 14/552,358

(22) Filed: Nov. 24, 2014

Related U.S. Application Data
(63) Continuation of application No. 12/590,187, filed on Nov. 3, 2009.
Application No. 12/590,187 is a continuation-in-part of application No. 12/472,270, filed on May 26, 2009.
(60) Provisional application No. 61/205,031, filed on Jan. 13, 2009.
(60) Provisional application No. 61/056,815, filed on May 28, 2008.

(51) Int. Cl. G06F 3/0482; G06F 3/0485

(52) U.S. Cl. CPC G06F 3/0482; G06F 3/0485

(57) ABSTRACT

An image browser alternates between displaying an image grid with less perspective distortion and displaying it with more perspective distortion. The distortion amount is determined by the grid's angle of rotation. If the angle is zero, then the view is perpendicular and has no distortion. In one embodiment, the user manually switches between the less distorted view and the more distorted view. In another embodiment, the switching of views is performed automatically based on whether the image grid is moving or stationary. If the image grid is moving, then it is shown with a more distorted view. If the image grid is stationary, then it is shown with a less distorted view. In yet another embodiment, the switching of views is performed automatically based on the scrolling velocity (i.e., speed and direction). In this embodiment, scrolling and tilting are integrated such that as scrolling velocity changes, tilt angle changes also.

### CROSS-REFERENCE TO RELATED APPLICATIONS

This application is a continuation of U.S. application Ser. No. 12/590,187, filed Nov. 3, 2009, which claims the benefit of U.S. Provisional Application No. 61/205,031, filed Jan. 13, 2009, and which is a continuation-in-part of U.S. application Ser. No. 12/472,270, filed May 26, 2009, which claims the benefit of U.S. Provisional Application No. 61/056,815, filed May 28, 2008, all of which are hereby incorporated by reference herein in their entirety.

### BACKGROUND

Field

The present invention relates generally to graphical user interfaces and more specifically to browsing multiple images.

Description of the Related Art

An image browser is a software application that enables a user to browse multiple images. A conventional image browser displays images arranged in rows and columns, sometimes referred to as a grid, table, or list. If the source images are large relative to the available screen space, it is difficult to display several of the source images simultaneously. In this situation, a conventional image browser displays “thumbnail” versions of the source images rather than the source images themselves. A thumbnail version of a source image is smaller and/or of a lower resolution than the source image.

Sometimes, the image grid is larger than the window that is used to display the grid. The window acts like a “viewport” on top of the image grid that allows certain parts of the grid (those parts that are underneath the viewport) to be displayed. In this situation, more images exist than are currently displayed. In order to view these images, the image grid is kept stationary, and the user moves the viewport relative to the image grid, thereby allowing different parts of the grid (those parts that are underneath the viewport based on the viewport's new position) to be displayed. Alternatively, the viewport is kept stationary, and the user moves the image grid relative to the viewport, thereby allowing different parts of the grid (those parts that have moved to be underneath the viewport) to be displayed. This navigation functionality is commonly referred to as scrolling.

In some image browsers, scrolling is constrained to be either vertical or horizontal. In other image browsers, the scrolling direction is unconstrained and can be in any direction (this is sometimes referred to as “panning”). Vertical or horizontal scrolling is usually performed by using a scroll bar or buttons. This type of user interaction generally reflects the “stationary-grid-moving-viewport” approach. Panning is usually performed by grabbing and dragging within the image grid area. This type of user interaction generally reflects the “stationary-viewport-moving-grid” approach.

In some image browsers, scrolling speed is constant (i.e., scrolling is either on or off). For example, if scrolling is performed using a button, then scrolling starts when the button is pressed and continues while the button is held down. When the button is released, the scrolling stops. In other image browsers, scrolling speed is variable (referred to as “rate-based scrolling”). For example, if rate-based scrolling is performed using a button, then scrolling starts when the button is pressed and continues while the button is held down. Over time, as the button is held down, the scrolling speed increases. When the button is released, the scrolling stops. Scrolling at high speed involves rapid movement through the image grid. This movement can cause blurring if it occurs too rapidly. The rapid visual flow can also reduce a user's ability to determine whether she has reached her target and cause the user to become disoriented.

One way to reduce the effect of rapid visual flow is to decrease the magnification level (“zoom level”) of the images, thereby reducing the image size or shrinking the images. This technique essentially “zooms out” from the image grid so that the images in the grid appear smaller than normal. For example, if a user plans to scroll quickly through an image grid, she first decreases the magnification level so that the images in the grid appear smaller. When she then scrolls quickly through the grid, the effect of the rapid visual flow is reduced. This makes it easier for her to browse the images.

The problem with zooming out in order to reduce the effect of rapid visual flow is that the images get smaller and, as a result, more difficult to see. More images can be displayed simultaneously, but the images themselves cannot be seen clearly. Also, if the grid is short in one dimension (e.g., not very wide with vertical scrolling or not very tall with horizontal scrolling), then zooming out will cause the display of a lot of empty space (beyond the edges of the grid). This empty space is useless to the user in terms of seeing images and browsing them quickly.

### SUMMARY

An image browser is a software application that enables a user to browse multiple images. Images are arranged in rows and columns, referred to as a grid. The image grid can be displayed with a perpendicular view or with a perspective view. In the perpendicular view, the viewpoint's position will be on a vector that is orthogonal to the grid plane, and the viewpoint will be oriented directly toward the grid. In the perspective view, the viewpoint is oriented toward the grid but is not located directly overhead the visible portion of the grid. As a result, the viewpoint appears to be “tilted” toward the grid.

Conventional image browsers always display the image grid using a perpendicular view. A new kind of image browser, referred to as a “perspective image browser,” is capable of alternating between a view with less perspective distortion and a view with more perspective distortion when displaying an image grid. The amount of perspective distortion is determined by the image grid's angle of rotation. Note that if the first angle of rotation is set to zero, then the “less distorted” view actually has no perspective distortion at all because the view is a perpendicular view.

In one embodiment, the user manually switches between the less distorted view (e.g., perpendicular view) and the more distorted view. In another embodiment, the switching of views is performed automatically based on whether the image grid is moving or stationary. If the image grid is moving, then the image grid is shown with a more distorted view using a particular rotation angle. If the image grid is stationary, then the image grid is shown with a less distorted view (e.g., perpendicular view). In yet another embodiment, the switching of views is performed automatically based on the scrolling velocity (i.e., speed and direction). In this embodiment, scrolling and tilting are integrated such that as scrolling velocity changes, tilt angle changes also.

In the “automatic” embodiments, when the image grid is stationary (i.e., not being scrolled), the perspective image browser displays the grid using a less distorted view (e.g., perpendicular view). This enables the user to view the images with less distortion (or no distortion at all). When the image grid is moving (i.e., being scrolled), the perspective image browser displays the grid using a more distorted view. This enables the user to see more images simultaneously, which reduces the effect of the rapid visual flow. When the image grid stops moving (i.e., stops scrolling), the perspective image browser once again displays the grid using a less distorted view (e.g., perpendicular view).

### BRIEF DESCRIPTION OF THE DRAWINGS

The patent or application file contains at least one drawing executed in color. Copies of this patent or patent application publication with color drawings will be provided by the U.S. Patent and Trademark Office upon request and payment of the necessary fee.

FIG. 1A shows a grid without perspective distortion.

FIG. 1B shows a grid with perspective distortion, according to one embodiment of the invention.

FIG. 2A shows an image grid displayed with a perpendicular view, according to one embodiment of the invention.

FIG. 2B shows a similar image grid as in FIG. 2A, but displayed with a perspective view, according to one embodiment of the invention.

FIG. 2C represents an intermediate point during the transition between the perpendicular view and the full perspective view.

FIG. 3A shows an image grid displayed with a perpendicular view, according to one embodiment of the invention.

FIG. 3B shows a similar image grid as in FIG. 3A, but displayed with a perspective view where the top is tilted away from the user, according to one embodiment of the invention.

FIG. 3C shows a similar image grid as in FIG. 3A, but displayed with a perspective view where the bottom is tilted away from the user, according to one embodiment of the invention.

FIG. 4A shows panoramic rotation, according to one embodiment of the invention.

FIG. 4B shows lunar rotation, according to one embodiment of the invention.

FIG. 4C shows trans-rotation, according to one embodiment of the invention.

FIG. 5A shows a first image grid with some unpopulated tiles, according to one embodiment of the invention.

FIG. 5B shows a second image grid with some unpopulated tiles, according to one embodiment of the invention.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The following description introduces a new kind of image browser. An image browser is a software application that enables a user to browse multiple images. The word “image” is meant to include any type of visual content. An image can be, for example, a photograph, a drawing, a frame of video, or text (e.g., a web page or other document or portion thereof). An image can represent, for example, a content item (e.g., an electronic file of any type) or an item for sale.

An image browser is generally used to browse a set of images. A set of images can represent, for example, a set of search results (e.g., items that satisfy a search query) or a set of items that are associated in some way (e.g., content items that are referred to by the same file, such as a web page, or content items that are stored in the same logical location, such as an electronic folder or album).

### Perspective Distortion

The problem with zooming out in order to reduce the effect of rapid visual flow is that the images get smaller and, as a result, more difficult to see. More images can be displayed simultaneously, but the images themselves cannot be seen clearly. Also, if the grid is short in one dimension (e.g., not very wide with vertical scrolling or not very tall with horizontal scrolling), then zooming out will cause the display of a lot of empty space (beyond the edges of the grid). This empty space is useless to the user in terms of seeing images and browsing them quickly.

What is needed is a way to display more images simultaneously yet not make the images too small to see. Since screen real estate (display space) is valuable, it should be used to display images, not to display empty space (like in the zoomed out view).

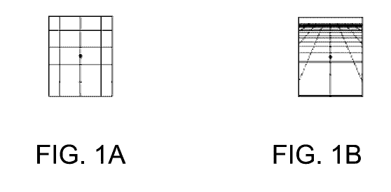

In one embodiment, an image grid is distorted or warped so that its appearance reflects what would be seen using a perspective view. FIG. 1A shows a grid without perspective distortion. Note that each grid space (“tile”) has four sides and that the angles are all 90 degrees. In other words, each tile is a rectangle. The grid in FIG. 1A represents, for example, the user interface of a conventional grid image browser, where each tile represents the location of an image.

FIG. 1B shows a grid with perspective distortion, according to one embodiment of the invention. Once again, each tile has four sides. However, the angles are no longer all 90 degrees. Now, some of the angles can be acute (less than 90 degrees), and some of the angles can be obtuse (more than 90 degrees). Also, one pair of opposing sides is parallel. In other words, each tile is no longer a rectangle—it is now a trapezoid. The grid in FIG. 1B represents, for example, the user interface of a new kind of grid image browser, where each tile represents the location of an image.

Note that although the grids shown in FIGS. 1A and 1B occupy the same amount of space in terms of viewport area, the perspective distortion in FIG. 1B enables more tiles to be displayed than in FIG. 1A. For example, in FIG. 1A, there is a dot in the center of the grid, with two full rows below the dot and two full rows above the dot. FIG. 1B also shows the dot, except that perspective distortion has caused there to be more than two full rows above the dot. Thus, in FIG. 1B, more tiles are displayed above the dot than in FIG. 1A.

One way to describe the difference between FIG. 1A and FIG. 1B is in terms of the angle of the grid with respect to the user (or, alternatively, to the viewport). In FIG. 1A, the grid is facing the user (and the viewport) directly and is not tilted in any way. In FIG. 1B, the grid is not facing the user (or the viewport) directly. Instead, the top of the grid is tilted away from the user (viewport), and the bottom of the grid is tilted toward the user (viewport).

Another way to describe the difference between FIG. 1A and FIG. 1B is in terms of how the grid is being viewed. In FIG. 1A, the grid is being viewed with a perpendicular view. A perpendicular view is like that of a camera aiming at a document from directly overhead the document, where the camera's line of sight is like a vector that is normal to the plane of the document. In FIG. 1B, the grid is being viewed with a perspective view. A perspective view is like that of a camera aiming at a document from overhead the document, but not directly overhead. Instead, the camera is off to one side of the document, so that the camera's line of sight is no longer normal to the plane of the document. Note that a particular view inherently defines a viewpoint. For a perpendicular view, the viewpoint (e.g., the camera in the previous example) is located along a vector that is oriented orthogonally to the plane of the document. For a perspective view, the viewpoint is located along a vector that is oriented non-orthogonally to the plane of the document.

Conventional image browsers always view the image grid using a perpendicular view. If the grid is “zoomable” (i.e., can be zoomed into and out of), then the viewpoint can be moved closer to or farther from the grid. However, the viewpoint's position will always be on a vector that is orthogonal to the grid plane, and the viewpoint will always be oriented directly toward the grid. The orientation (rotational position) of the viewpoint does not change. In the perspective view, the viewpoint is oriented toward the grid but is not located directly overhead the visible portion of the grid. As a result, the viewpoint appears to be “tilted” toward the grid.

Perspective distortion is further discussed in “Allowing Camera Tilts for Document Navigation in the Standard GUI: A Discussion and an Experiment”, Guiard, Y., et al., Proceedings: Advanced Visual Interfaces (AVI), Venice, Italy, May 23-26, 2006, pp. 241-244.

### Exemplary Image Grids

As explained above, the perspective view of a grid enables more tiles to be displayed in the same amount of space compared with a perspective view. If each tile represents an image, then the perspective view of an image grid enables more images to be displayed in the same amount of space compared with a perspective view.

One way to use perspective view in an image browser is to always display the image grid using a perspective view. This technique will maximize the number of images shown at all times. The problem with the perspective view, of course, is that it distorts the images. If the perspective view is always used, then the images are always distorted.

A new kind of image browser, referred to as a “perspective image browser,” is capable of alternating between a view with less perspective distortion and a view with more perspective distortion when displaying an image grid. The amount of perspective distortion is determined by the image grid's angle of rotation. For example, a smaller angle of rotation yields less distortion, while a larger angle of rotation yields more distortion. In one embodiment, the image grid's first angle of rotation (for the “less distorted” view) and/or second angle of rotation (for the “more distorted” view) are configurable. Note that if the first angle of rotation is set to zero, then the “less distorted” view actually has no perspective distortion at all because the view is a perpendicular view.

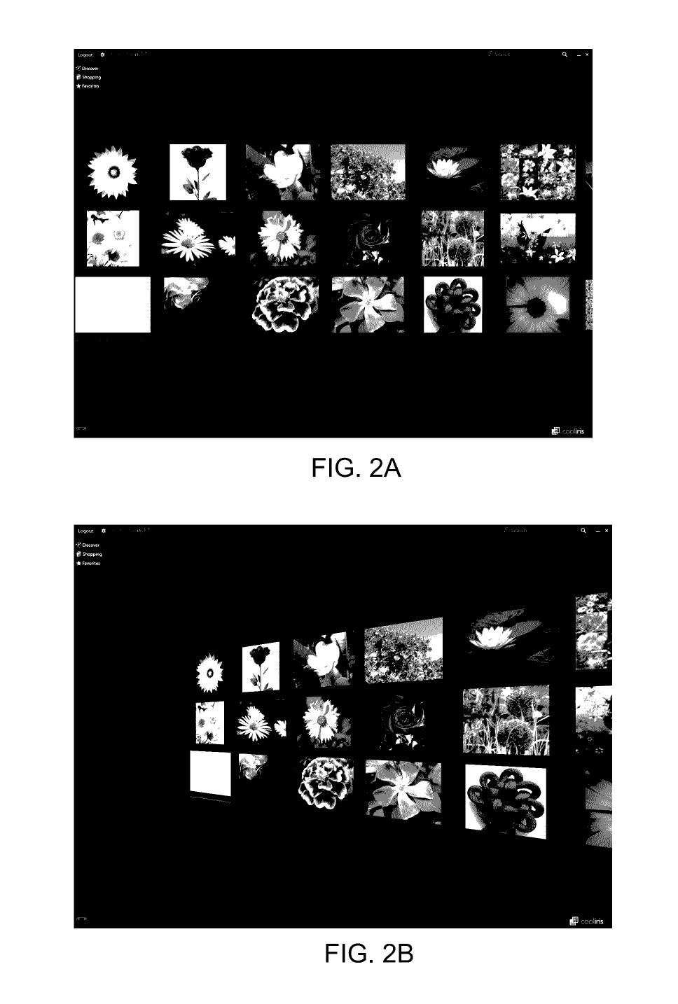

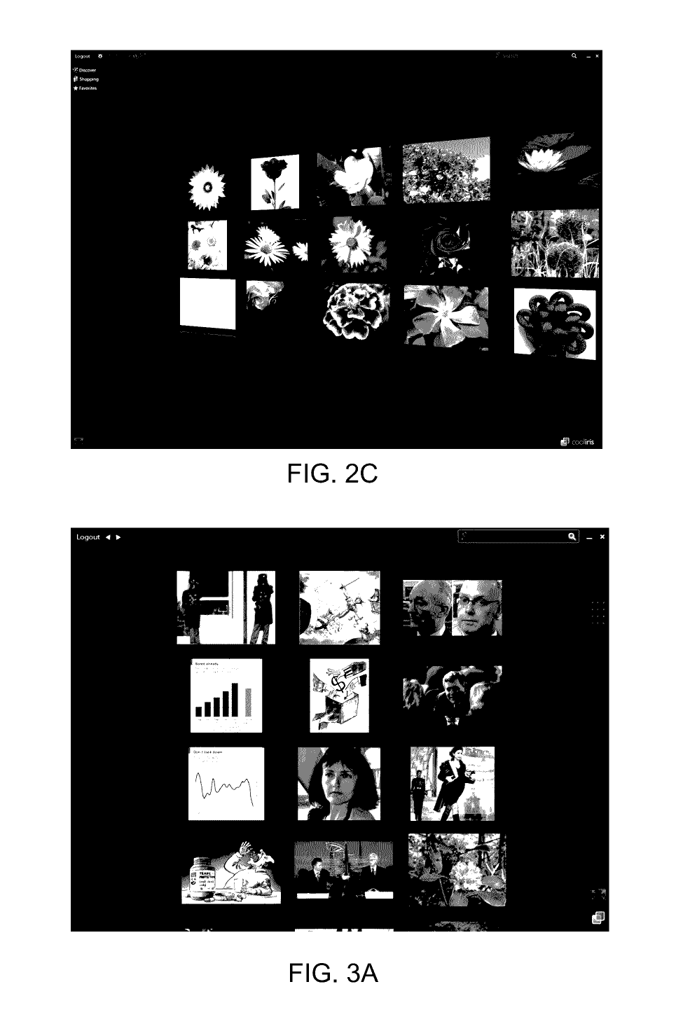

FIG. 2A shows an image grid displayed with a perpendicular view, according to one embodiment of the invention. The image grid in FIG. 2A represents, for example, a first user interface of a perspective image browser. FIG. 2B shows a similar image grid as in FIG. 2A, but displayed with a perspective view, according to one embodiment of the invention. The image grid in FIG. 2B represents, for example, a second user interface of a perspective image browser.

Note that a perspective image browser can display image grids that differ from the image grids that are shown in FIGS. 2A and 2B. For example, although each tile in FIG. 2A is rectangular (and each tile in FIG. 2B is a perspective distortion thereof), a tile can be any shape. Also, although each tile in FIG. 2A contains one image, a tile can contain any number of images (and possibly also additional content, such as text that describes the image). A tile can also include a border and/or padding. While FIGS. 2A and 2B show a black background behind the image grid, the background can be a different color, include a pattern, and/or show an image. In one embodiment, these properties of a grid interface are configurable.

The type of perspective distortion can also be different. For example, the perspective distortion applied to the grid in FIG. 2A results in the left side of the grid tilting away from the user (as shown in FIG. 2B). Applying a different type of perspective distortion can result in, for example, the right side of the grid tilting away from the user (not shown). In both of these examples, the axis of rotation for the grid is vertical.

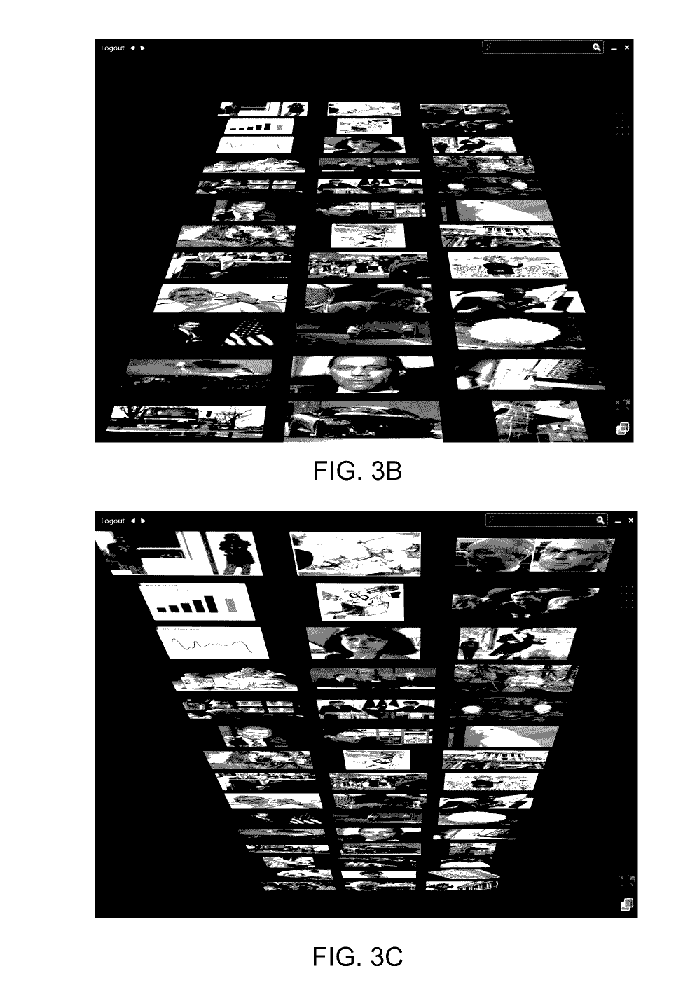

Alternatively, the axis of rotation could be horizontal. In that situation, applying perspective distortion to a perpendicular view grid would result in the top of the grid tilting away from the user or the bottom of the grid tilting away from the user. FIG. 3A shows an image grid displayed with a perpendicular view, according to one embodiment of the invention. FIG. 3B shows a similar image grid as in FIG. 3A, but displayed with a perspective view where the top is tilted away from the user, according to one embodiment of the invention. FIG. 3C shows a similar image grid as in FIG. 3A, but displayed with a perspective view where the bottom is tilted away from the user, according to one embodiment of the invention.

Of course, the axis of rotation need be neither exactly vertical nor exactly horizontal—it can be at any angle whatsoever within the plane of the image grid. In one embodiment, the type of perspective distortion of the grid interface is configurable.

Scrolling

In one embodiment, the user manually switches between the less distorted view (e.g., perpendicular view) and the more distorted view. For example, if the user plans to scroll quickly through the image grid, she first displays the grid using the more distorted view so that the grid appears tilted (or more tilted). When she then scrolls quickly through the grid, the effect of the rapid visual flow is reduced. This makes it easier for her to browse the images. When she finds a portion of the grid that interests her, she stops scrolling and displays the grid using the less distorted view (e.g., perpendicular view).

In another embodiment, the switching of views is performed automatically based on whether the image grid is moving or stationary. If the image grid is moving, then the image grid is shown with a more distorted view using a particular rotation angle. If the image grid is stationary, then the image grid is shown with a less distorted view (e.g., perpendicular view).

In yet another embodiment, the switching of views is performed automatically based on the scrolling velocity (i.e., speed and direction). In this embodiment, scrolling and tilting are integrated such that as scrolling velocity changes, tilt angle changes also. Scrolling and tilting are unified by automatically adjusting the tilt angle during scrolling. A single user action interdependently controls both scrolling (viewpoint translation, both speed and direction) and tilting (viewpoint rotation).

In this “automatic” embodiment, when the image grid is stationary (i.e., not being scrolled), the perspective image browser displays the grid using a less distorted view (e.g., perpendicular view). This enables the user to view the images with less distortion (or no distortion at all). When the image grid is moving (i.e., being scrolled), the perspective image browser displays the grid using a more distorted view. This enables the user to see more images simultaneously, which reduces the effect of the rapid visual flow. (The perpendicular view prevents the user from looking ahead while navigating the grid. As a result, fast navigation (e.g., fast scrolling) causes the user to experience rapid visual flow.) When the image grid stops moving (i.e., stops scrolling), the perspective image browser once again displays the grid using a less distorted view (e.g., perpendicular view).

The direction of the perspective distortion (and the axis of rotation, which defines the distortion) is determined by the direction of the scrolling. For example, if the grid is being scrolled horizontally (i.e., left or right), the perspective distortion is also horizontal (and the axis of rotation is vertical), such that each row of the grid has one end that appears closer to the user and one end that appears farther from the user. The grid appears to have rotated around a vertical axis. In FIG. 2B, the grid was being scrolled horizontally, so the perspective distortion was also horizontal. As a result, each row of the grid has one end that appears closer to the user and one end that appears farther from the user.

The image grid in FIGS. 2A and 2B has a fixed number of rows (three) and a variable number of columns (depending on how many images are in the set of images). Although the image grid in FIGS. 2A and 2B includes three rows, an image grid can have any number of rows (including so many rows that some of the rows are off-screen because they cannot all be displayed simultaneously). In one embodiment, the fixed number of rows is configurable.

If the grid is being scrolled vertically (i.e., up or down), the perspective distortion is also vertical (and the axis of rotation is horizontal), such that each column of the grid has one end that appears closer to the user and one end that appears farther from the user. The grid appears to have rotated around a horizontal axis. In FIGS. 3B and 3C, the grid was being scrolled vertically, so the perspective distortion was also vertical. As a result, each column of the grid has one end that appears closer to the user and one end that appears farther from the user.

The image grid in FIGS. 3B and 3C has a fixed number of columns (three) and a variable number of rows (depending on how many images are in the set of images). Although the image grid in FIGS. 3B and 3C includes three columns, an image grid can have any number of columns (including so many columns that some of the columns are off-screen because they cannot all be displayed simultaneously). In one embodiment, the fixed number of columns is configurable.

In one embodiment, scrolling can occur in any direction. In this embodiment, the axis of rotation is orthogonal to the scrolling direction such that the grid is tilted either towards or away from the scrolling direction. For example, if the scrolling direction is towards the upper-left corner of the screen (e.g., north-west), then the axis of rotation will be at a 45 degree angle (running north-east to south-west), and the grid will tilt either towards or away from the upper-left corner of the screen.

When a grid is scrolled, the tiles on one side of the grid are entering the screen (i.e., appearing), and the tiles on the opposite side of the grid are leaving the screen (i.e., disappearing). In one embodiment, the tiles that are entering the screen are shown farther away from the user (i.e., that portion of the grid is tilted away from the user). As the grid scrolls, those same tiles reach the middle of the screen and continue on, getting closer to the user. Eventually, right before the tiles scroll off the screen, they are as close to the user as they will ever be. Alternatively, in another embodiment, the tiles that are leaving the screen are shown farther away from the user (i.e., that portion of the grid is tilted away from the user).

If the perspective image browser switched immediately between the less distorted view (e.g., perpendicular view) and the more distorted view, the visual effect would be jarring to the user's senses. In one embodiment, the perspective image browser switches gradually between the less distorted view and the more distorted view. For example, assume that the perspective image browser is displaying the grid using a less distorted view (because the grid is stationary). As the grid starts to scroll, the viewpoint slowly changes its location and/or orientation so that its line of sight slowly changes from directly overhead the visible portion of the grid (if the less distorted view was the perpendicular view) or barely off to the side of the visible portion of the grid (if the less distorted view was not the perpendicular view) to off to the side (or further off to the side) of the visible portion of the grid. In this way, the switch between the less distorted view and the more distorted view is animated smoothly.

For example, FIG. 2A shows an image grid displayed with a perpendicular view, according to one embodiment of the invention. FIG. 2A represents what would be displayed before the transition between the less distorted view (here, the perpendicular view) and the more distorted view has begun. FIG. 2B shows the same image grid as in FIG. 2A, but displayed with a perspective view, according to one embodiment of the invention. FIG. 2B represents what would be displayed after the transition between the less distorted view and the more distorted view has finished. FIG. 2C represents an intermediate point during the transition between the less distorted view and the full more distorted view. Note that the image grid in FIG. 2C has been rotated somewhat, but not as much as in FIG. 2B.

In one embodiment, if the scrolling speed is higher, then the transition between the less distorted view and the more distorted view is shorter (i.e., it happens more quickly). If the scrolling speed is lower, then the transition between the less distorted view and the more distorted view is longer (i.e., it happens more slowly). In other words, the view of the image grid is modified automatically based on the scrolling speed. This feature, referred to as speed-dependent automatic distortion (SDAD), integrates rate-based scrolling with automatic perspective distortion. When a user scrolls rapidly, the view automatically distorts so that the perceptual scrolling speed in screen space remains constant. As a result, the user can efficiently and smoothly navigate over a large area without becoming disoriented by extremely fast visual flow.

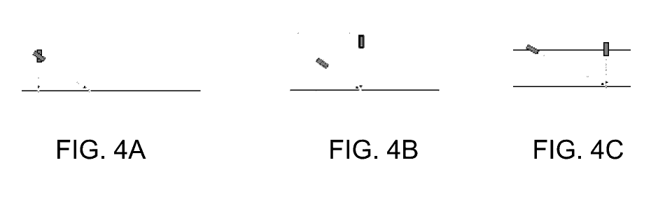

As the perspective image browser transitions between the less distorted view of the grid and the more distorted view of the grid, the appearance of the grid changes. Exactly how the grid's appearance changes depends on the technique used to tilt the viewpoint (with respect to the grid). One tilting technique is panoramic rotation, where the viewpoint stays in the same place but rotates. FIG. 4A shows panoramic rotation, according to one embodiment of the invention. In FIG. 4A, the camera (viewpoint) is initially pointing straight down at the grid. Then, the camera rotates so that it is pointing at the grid off at an angle. Note that panoramic rotation causes the viewpoint to point towards a different portion of the grid.

In another tilting technique, the viewpoint moves around the grid in an arc and rotates so that the same portion of the grid remains visible. This technique is referred to as lunar rotation because the viewpoint appears to “orbit” a point in the grid. FIG. 4B shows lunar rotation, according to one embodiment of the invention. In FIG. 4B, the camera (viewpoint) is initially pointing straight down at the grid. Then, the camera both moves (counterclockwise) and rotates (also counterclockwise) so that it is still pointing at the same portion of the grid but off at an angle. Note that lunar rotation enables the user to view a distant region of the grid without losing sight of the region that was already visible (prior to rotation).

In yet another tilting technique, the viewpoint moves at a fixed altitude (above the grid) and rotates so that the same portion of the grid remains visible. This technique is referred to as trans-rotation because the viewpoint translates. FIG. 4C shows trans-rotation, according to one embodiment of the invention. In FIG. 4C, the camera (viewpoint) is initially pointing straight down at the grid. Then, the camera both translates (moves) to the left and rotates (counterclockwise) so that it is still pointing at the same portion of the grid but off at an angle.

### Global View and Intermediate View

If an image grid contains too many tiles to be displayed all at once in its entirety, the user can scroll the grid to view additional portions. As the number of tiles increases, it becomes more and more difficult for the user to know which portion of the grid is currently being displayed. This makes it harder for the user to navigate the grid because she doesn't know how big the entire grid is or where the edges of the grid are (relative to the visible portion).

One way to alleviate this problem is to display a second view of the grid (referred to as a “global view”) that compactly represents the entire grid. The global view gives the user an overview of the grid. A field-of-view indicator indicates which portion of the grid is currently visible (e.g., which portion of the grid is represented by the user interfaces in FIG. 2A, 2B, or 2C or FIG. 3A, 3B, or 3C). In this way, the field-of-view indicator represents the viewport. Since the global view represents off-screen tiles, it gives the user context regarding the grid portion that is visible (the detail view) relative to the portion that is not visible. In order to distinguish between different types of views of the grid, the views shown in FIGS. 2A, 2B, and 2C and FIGS. 3A, 3B, and 3C will henceforth be referred to as “detail views.”

The global view uses an icon or shape (e.g., a dot) to represent a tile. The dots are arranged in the same way as the tiles. For example, the grid portion that is visible in FIG. 2A (detail view) includes eighteen tiles arranged in three rows and six columns. The corresponding global view representation of this portion would be eighteen dots arranged in three rows and six columns. If the image grid extends beyond the visible portion (detail view), then the global view will also represent all of the off-screen tiles, using one dot per tile. For example, if the grid includes more than six columns, then additional dots will be shown alongside the original eighteen dots, representing where the additional tiles are located.

Once an image grid has been configured, its tile layout stays the same, regardless of how many tiles are in the grid. Since the global view dots are arranged in the same way as the tiles, the dot layout also stays the same, regardless of how many dots are in the global view.

The global view's field-of-view indicator visually distinguishes the field-of-view dots (the dots that represent tiles that are currently visible in the detail view) from the remaining dots (the dots that represent tiles that are currently off-screen relative to the detail view). Any type of visual effect can be used to distinguish the dots. For example, the field-of-view dots can be shown against a different background than the remaining dots (such that the field-of-view dots appear to be highlighted). As another example, the field-of-view dots can be surrounded by a shape (e.g., a rectangle), while the remaining dots are not. In one embodiment, the field-of-view dots are shown in a first color (blue), while the remaining dots are shown in a second color (gray). Additional colors can be used to indicate additional information, such as a third color (gold) indicating that the corresponding tile has been flagged.

In FIGS. 2A, 2B, and 2C, the global view is located underneath the detail view, along the bottom edge of the window. In FIGS. 3A, 3B, and 3C, the global view is located to the right of the detail view, along the right edge of the window.

The problem with the global view is that the size of the field-of-view indicator depends on the ratio of the size of the viewport relative to the size of the entire grid. If the number of tiles that can be shown in the viewport is very small relative to the number of tiles in the entire grid, then the field-of-view indicator will be very small (and, therefore, difficult to see). This problem is similar to the “zooming out” problem that was discussed in the Background section. The global view is similar to a zoomed out view of the grid where the tiles have been replaced by dots. What is needed is a way to give the user more context than is provided in the detail view yet not make the field-of-view indicator too small to see.

In one embodiment, the size of the field-of-view indicator is maintained regardless of the size of the grid. In this embodiment, if the grid is too big (such that the field-of-view indicator would be smaller than the designated size), then only a portion of the global view is shown, rather than the entire global view. This type of view will henceforth be referred to as an “intermediate view.”

The intermediate view represents all of the tiles that are currently visible (i.e., those that are shown in the detail view) and some (but not necessarily all) of the tiles that are not visible (i.e., the tiles that are off-screen). Since the intermediate view represents at least some of the off-screen tiles, it gives the user some context regarding the grid portion that is visible (detail view) relative to the portion that is not visible.

The intermediate view is therefore either the entire global view or a portion thereof. If dots are shown at the edge of the intermediate view area, it is unclear whether those dots represent the edge of the grid or whether additional dots exist that are part of the global view but are not included in the intermediate view. In one embodiment, an icon is shown within the intermediate view to indicate that no more dots exist past the icon. For example, the icon can be a line located next to the last column of dots. The line represents the edge of the grid.

The intermediate view is coordinated with the detail view. When the detail view is moved (e.g., scrolled), the visible portion of the grid changes, and the intermediate view is updated to reflect the new position of the field-of-view indicator. For example, assume that the viewport is in the center of the grid and that the field-of-view indicator is therefore also centered in the middle of the intermediate view. If the detail view were scrolled, the field-of-view indicator would move to show which part of the grid became visible.

When the field-of-view indicator is centered within the intermediate view, information is displayed about the tiles closest to the visible tiles. These tiles are the ones that the user is mostly likely to navigate to next. In one embodiment, in order to ensure that this information is presented to the user, the position of the intermediate view (with respect to the larger global view) is automatically adjusted so that the field-of-view indicator is centered in the middle of the intermediate view.

### User Interaction

Many different user interaction techniques can be used to scroll the image grid (and thereby tilt the image grid, if tilting is automatically triggered by scrolling). For example, the user can “mouse down” on a button that causes the grid to scroll. Different buttons can cause the grid to scroll in different directions. As another example, the user can activate a scroll bar. Different scroll bars can cause the grid to scroll in different directions. As yet another example, the user can hover over or click within a particular region of the display (sometimes called a “hotspot”). Different hotspots can cause the grid to scroll in different directions. In one embodiment, when a user ceases to activate a scroll control (such as a button or hotpot), the image grid stops scrolling immediately. In another embodiment, the image grid continues to scroll, but the scrolling speed decays over time, which results in the scrolling eventually slowing down and stopping. The scrolling speed decay makes it seem like the scrolling is being affected by friction. If the angle of rotation of the image grid is based on the scrolling speed, then the angle of rotation will decay as the scrolling speed decays.

In one embodiment, scrolling is performed by grabbing and dragging (sometimes referred to as “sticky hand”). Grabbing and dragging can be performed using any pointing device, such as a mouse, trackball, pointing stick, or touch screen. The user mouses down somewhere within the detail view, moves the cursor (thereby “dragging” the grid and changing its position), and then mouses up. This causes a different portion of the grid to become visible. (If an intermediate view is displayed, the intermediate view is updated accordingly so that it reflects the new position of the grid.) This type of user interaction generally reflects the “stationary-viewport-moving-grid” approach.

Grabbing and dragging the detail view like this will result in scrolling the detail view one visible portion at a time (at the most—since the largest drag distance is from one edge of the visible portion to the opposite edge). Many grab-and-drags may be required to move the grid to the desired location. In one embodiment, in order to decrease the amount of time needed to perform the grab-and-drags, the user is allowed to initiate a second grab-and-drag while the grid is still scrolling due to a first grab-and-drag. In other words, the user need not wait for the grid to come to a complete stop before initiating another grab-and-drag.

In one embodiment, grabbing and dragging is also supported by the intermediate view. For example, the field-of-view indicator can be grabbed and dragged within the intermediate view so that it indicates a different set of dots. (Alternatively, the user can click within the intermediate view, and the field-of-view indicator will be moved to that location.) The detail view will be scrolled accordingly. The intermediate view represents more tiles than can be visible within the detail view. Thus, a single grab-and-drag within the intermediate view can cause the image grid to scroll farther than a single grab-and-drag within the detail view. After the grab-and-drag (or after the click), the intermediate view will reposition itself so that the field-of-view indicator is centered again. Similar to the detail view, the user is allowed to initiate a second grab-and-drag while the intermediate view is still repositioning itself due to a first grab-and-drag.

### Exemplary Implementation

Scrolling—Each location of the grid relative to the viewport (or, alternatively, each location of the viewport relative to the grid) is characterized by a “scroll position.” When the image grid is stationary, it has a first scroll position (“initial scroll position”). A user input then indicates a second scroll position (“target scroll position”). Keyframe animation is used to animate the grid so that it appears to tilt and scroll between the initial scroll position and the target scroll position. Images of the grid in various stages of tilting and scrolling (i.e., intermediate keyframes) are generated and displayed sequentially to produce the animation.

As mentioned above, different types of user input can be used to scroll the grid. In one embodiment, if the user input is a grab-and-drag in the detail view followed by a release, then the location of the cursor on the mouse down (the “grab”) represents the initial scroll position, and the location of the cursor on the mouse up (after the “drag” is over) represents the target scroll position. The speed of the drag does not affect the target scroll position.

In one embodiment, if the user input is a grab-and-drag in the detail view without a release (i.e., without a mouse up), then the grid continues to scroll. The speed of the drag affects the speed of the scroll, such that a faster drag results in a faster scroll. For example, the scrolling speed is determined by the cursor velocity when the cursor reaches the edge of the detail view. In one embodiment, the scrolling speed decays over time, which results in the scrolling eventually slowing down and stopping, even if the user has not released (moused up). The scrolling speed decay makes it seem like the scrolling is being affected by friction. If the angle of rotation of the image grid is based on the scrolling speed, then the angle of rotation will decay as the scrolling speed decays.

Any animation technique can be used to scroll and tilt the grid from its initial scroll position to its target scroll position. In one embodiment, an iterative function is used, where the grid's scroll position in each intermediate frame is a weighted average of the scroll position in the previous frame and the target scroll position. In this embodiment, the scrolling is fast initially and slows down as the grid approaches its target scroll position. In another embodiment, a parameterized function is used, where the grid scrolls from the initial scroll position to the target scroll position over a period of time, and that time value is used to determine the scroll position for each intermediate frame.

Tilting—The tilting of the grid is based on the scroll positions. Given a current scroll position and a target scroll position, a “target tilt angle” is determined. The target tilt angle is proportional to the velocity of the grid as the grid is scrolling. The tilt angle for each frame is determined such that the tilt angle is continuously interpolated towards the target tilt angle.

Intermediate view—If the user initiates a scroll from within the detail view, then as the current scroll position changes and approaches the target scroll position, the position of the intermediate view (with respect to the larger global view) is automatically adjusted so that the field-of-view indicator is centered in the middle of the intermediate view. In one embodiment, the field-of-view indicator specifies which tiles will be shown in the detail view when the grid is at rest. In this embodiment, if the grid is scrolling, the field-of-view indicator specifies which tiles will be shown in the detail view when the grid has reached its target scroll position.

If the user initiates a scroll from within the intermediate view (e.g., by moving the field-of-view indicator), the target position is determined, and then the wall starts to scroll. After the user has moused up, the position of the intermediate view is automatically adjusted so that the field-of-view indicator is centered in the middle of the intermediate view.

Tile population—Tile population includes obtaining content to show in tiles (e.g., images and text) and generating the tiles (e.g., combining the images with the text). In one embodiment, tiles are populated from the visual center of the grid outward. For example, the visual center of the grid is determined. Resources are loaded in priority order from the visual center outwards. In one embodiment, a tile is populated even if it is not currently being displayed. For example, assume that a first set of tiles is currently being displayed without any scrolling (i.e., stationary). The tiles that are adjacent to the displayed tiles are also populated. This way, if the user scrolls the grid to show the adjacent tiles, those tiles are ready to be displayed.

As the grid is scrolled, the visual center is continuously re-computed. Returning to the previous example, assume that the first set of tiles is currently being displayed without any scrolling. Now, the user issues a scrolling command that causes the grid to be scrolled the equivalent of five screens (i.e., five sets of tiles, each of which would occupy one screen). The visual center is determined to be within the destination screen (i.e., that area of the grid), and the tiles are populated from that point outward. This means that the tiles in the destination set will be populated before the tiles that are located in the grid between the first set of tiles and the destination set of tiles. In this way, content that the user is likely to see immediately is retrieved first.

In one embodiment, a tile is populated as follows: First, the content (e.g., an image and/or text) is requested. Then, if the aspect ratio of the content is known, the dimensions of the tile are set accordingly. For example, if the content is an image referenced by an HTML <IMG> tag, then the <IMG> tag might include the height and width of the image as attributes. These attributes can be used to set the dimensions of the tile.

At this point in the population process, the content may not have been received yet. Since the content is not available, the tile can display instead a color, pattern, or image as a placeholder. For example, if the image grid represents a set of items for sale, then the tile can display the logo of the store that is selling the items. In one embodiment, the tile is filled with the color black or a black gradient.

When the content is received, it is used to create an image that will be used for the tile. When the tile is displayed (rendered), the created image is displayed. In one embodiment, when the created image is first displayed, its brightness is set to a low level. Then, over time, the brightness level is increased until the original created image is shown. The effect is that the created image seems to “fade in” over time. The fade-in effect can occur over a fixed period of time, or the period of time can vary based on the scrolling speed (e.g., if the scrolling is faster, then the period of time is shortened, which causes the fade-in to occur faster). The fixed period of time can be configurable. In another embodiment, the original created image is shown immediately, without a fade-in effect.

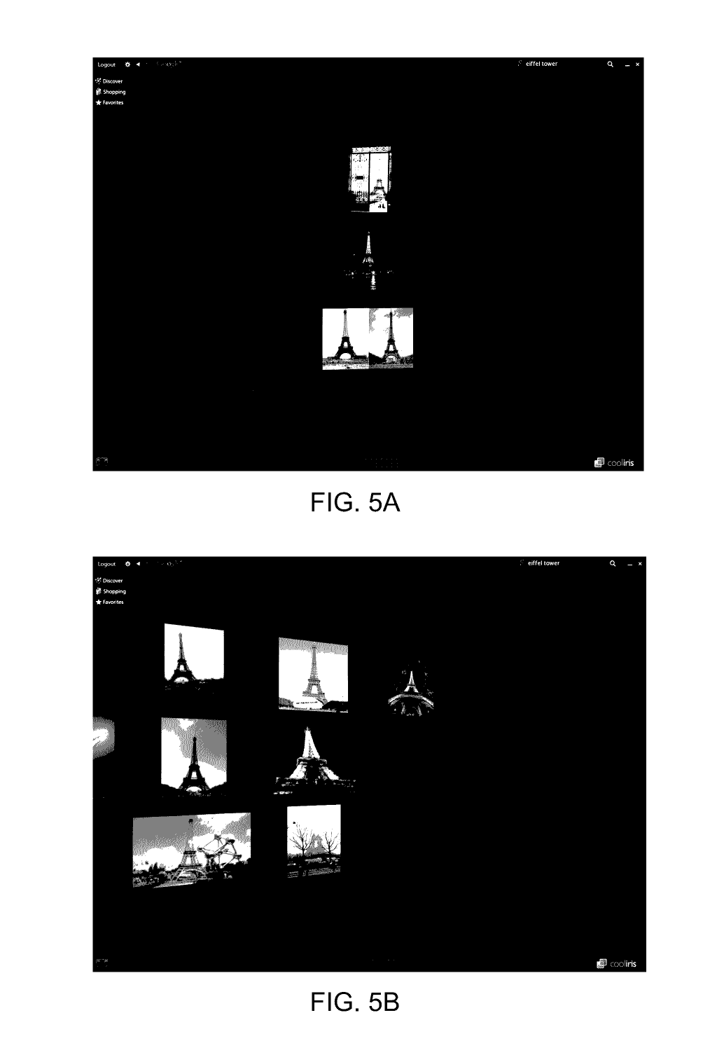

FIG. 5A shows a first image grid with some unpopulated tiles, according to one embodiment of the invention. In FIG. 5A, the detail view shows fifteen tiles arranged in three rows and five columns. The tiles in the center column have been populated and are showing content in its original form. The tiles in the second column from the left have also been populated but are showing content with decreased brightness (so that the content appears to be “fading in”). The remaining tiles have not been populated yet.

FIG. 5B shows a second image grid with some unpopulated tiles, according to one embodiment of the invention. In FIG. 5B, the detail view shows eighteen tiles arranged in three rows and six columns. The tiles in the first and second columns from the left have been populated and are showing content in its original form. In the third column from the left, the top tile has been populated and is showing content in its original form. The bottom tile in this column has also been populated but is showing content with decreased brightness (so that the content appears to be “fading in”). The middle tile in this column has not been populated yet.

In one embodiment, the tile population strategy is modified based on input received from an eye-tracking device. The eye-tracking device indicates where the user is looking That location is used as the visual center, and the tiles are populated starting there and going outwards. The eye-tracking input can also be used to enhance the level of detail in areas where the eye is pointing. For example, images that are shown in this area can be shown at a higher resolution than images in other areas (i.e., areas where the user is not looking).

After the contents of a tile have been generated, they are cached. If the cache becomes full, the tile that is farthest away from the field-of-view indicator (i.e., farthest away from being visible) is identified, and its contents are evicted from the cache.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing device, that manipulates and transforms data represented as physical (electronic) quantities within the computer system memories or registers or other such information storage or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a tangible computer-readable (or machine-readable) storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description. In addition, the present invention is not described with reference to any particular programming language. It will be appreciated that a variety of programming languages may be used to implement the teachings of the present invention as described herein, and any references to specific languages are provided for disclosure of enablement and best mode of the present invention.

As will be understood by those familiar with the art, the invention may be embodied in other specific forms without departing from the spirit or essential characteristics thereof. Likewise, the particular naming and division of the modules, features, attributes, methodologies, managers and other aspects are not mandatory or significant, and the mechanisms that implement the invention or its features may have different names, divisions and/or formats. Furthermore, as will be apparent to one of ordinary skill in the relevant art, the modules, features, attributes, methodologies, managers and other aspects of the invention can be implemented as software, hardware, firmware or any combination of the three. Of course, wherever a component of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

In addition, the language used in the specification has been principally selected for readability and instructional purposes and may not have been selected to delineate or circumscribe the inventive subject matter. Accordingly, the disclosure of the present invention is intended to be illustrative, but not limiting, of the scope of the invention, which is set forth in the following claims.

1. A method comprising:
when an image in an image browser is stationary, automatically displaying, in the image browser by a processor, the image using a first angle of rotation relative to an axis of rotation; and
when the image in the image browser is moving, automatically displaying, by the processor, the image with a second angle of rotation relative to the axis of rotation, the second angle of rotation greater than the first angle, the axis of rotation perpendicular to a direction in which the image is moving.

2. (canceled)

3. A method comprising:
displaying, by a processor, a first plurality of stationary images using a first angle of rotation relative to an axis of rotation;
responsive to receiving a command to start scrolling including a scrolling direction and a scrolling velocity, modifying, by the processor, the displayed first plurality of images to display a second plurality of moving images using a second angle of rotation relative to the axis of rotation, the second angle of rotation greater than the first angle, the axis of rotation orthogonal to the scrolling direction; and
responsive to receiving a command to stop scrolling, displaying, by the processor, a third plurality of stationary images using the first angle of rotation relative to the axis of rotation.

4. A method comprising:
displaying, by a processor, a first plurality of images from an image grid using a zero angle of rotation relative to an axis of rotation;
responsive to receiving a command to start scrolling the first plurality of images in a scrolling direction at a scrolling velocity, modifying, by the processor, the displayed first plurality of images to display a second plurality of images from the image grid, the second plurality of images moving, using a non-zero angle of rotation relative to the axis of rotation, the axis of rotation orthogonal to the scrolling direction; and
responsive to receiving a command to stop scrolling, displaying, by the processor, a third plurality of images from the image grid using the zero angle of rotation relative to the axis of rotation, the third plurality of images stationary.

5. The method of claim 4, wherein a horizontal scrolling direction movement results in a vertical axis of rotation.

6. The method of claim 4, wherein the displayed first plurality of images, the second plurality of moving images, and the third plurality of stationary images are arranged in a format type selected from a group of format types consisting of columns and rows.

7. (canceled)

8. (canceled)

9. (canceled)

10. The method of claim 4, further comprising displaying an intermediate view of the images, the intermediate view comprising:
a representation of each image in the image grid; and
a field-of-view indicator that indicates which images in the image grid are currently being displayed.

11. (canceled)

12. The method of claim 10, wherein the field-of-view indicator comprises a shape surrounding or underlying the representations of the images in the image grid that are currently being displayed.

13. (canceled)

14. (canceled)

15. (canceled)

16. The method of claim 10, wherein the field-of-view indicator moves within the intermediate view while the second plurality of images is displayed.

17. The method of claim 10, wherein the field-of-view indicator is stationary and centered within the intermediate view while the third plurality of images is displayed.

18. The method of claim 4, further comprising displaying an intermediate view of the images that indicates a relative viewing position within the image grid.

19. The method of claim 4, further comprising displaying an intermediate view of the images that indicates which images in the image grid are currently being displayed.

20. The method of claim 4, further comprising displaying an intermediate view of the images that resembles an array of lights.

21. The method of claim 20, wherein only those lights within the array of lights that correspond to images being viewed are highlighted.

22. The method of claim 20, wherein the array of lights mimics the image grid.

23. The method of claim 4, further comprising displaying an intermediate view of the images that comprises a representation of each image in the image grid.

24. A method comprising:
determining, by a processor, a first portion of a grid of images, the grid currently being displayed;
determining, by the processor, a second portion of the grid that is not currently being displayed and that is adjacent to the first portion;
requesting, by the processor and for each image in the second portion, either an image file or a uniform resource identifier (URI) of the image file;
receiving, by the processor, a command to display the second portion, wherein the second portion comprises a plurality of tiles; and
responsive to the image files or the URIs of the images in the second portion having been received, displaying, by the processor and within each tile, an image from the images in the second portion.

25. The method of claim 24, wherein displaying, within each tile, the image from the images in the second portion comprises displaying images for tiles centered within the second portion before displaying images for tiles located away from the center of the second portion.

26. The method of claim 24, wherein displaying, within each tile, the image from the images in the second portion comprises displaying the image with a “fade in” effect by increasing the image's brightness over time.

27. The method of claim 24, further comprising:
responsive to the image files or the URIs of the images in the second portion not yet having been received,
displaying, within each tile, a color, a pattern, or a substitute image.

28. (canceled)

29. A system for comprising:
a processor;
a storage medium for tangibly storing thereon program logic for execution by the processor, the stored program logic comprising:
zero angle display logic executed by the processor for displaying a first plurality of images from an image grid using a zero angle of rotation relative to an axis of rotation;
scrolling start display logic executed by the processor for, responsive to receiving a command to start scrolling the first plurality of images in a scrolling direction at a scrolling velocity, modifying the displayed first plurality of images to display a second plurality of images from the image grid, the second plurality of images moving, using a non-zero angle of rotation relative to the axis of rotation, the axis of rotation orthogonal to the scrolling direction; and
scrolling stop display logic executed by the processor for, responsive to receiving a command to stop scrolling,
displaying a third plurality of images from the image grid using the zero angle of rotation relative to the axis of rotation, the third plurality of images stationary.
